(19) United States
(12) Patent Application Publication
(10) Pub. No.: US 2026/0247034 A1
(43) Pub. Date: Aug. 20, 2026

(54) CONTROLLING APPARATUS USED FOR AN IMAGING SYSTEM INCLUDING LENS APPARATUS AND IMAGING APPARATUS

(71) Applicant: CANON KABUSHIKI KAISHA, Tokyo (JP)

(72) Inventor: YU MITSUDA, Tochigi (JP)

(21) Appl. No.: 19/538,050

(22) Filed: Feb. 12, 2026

(30) Foreign Application Priority Data
Feb. 17, 2025 (JP) 2025-023208

(51) Int. Cl. H04N 23/67; H04N 23/55; H04N 23/63

(52) U.S. Cl. CPC H04N 23/671; H04N 23/55; H04N 23/633

(57) ABSTRACT

Provided is a controlling apparatus used for an imaging system including a lens apparatus and an imaging apparatus, in which the controlling apparatus is configured to: acquire optical information that includes first information relating to a position of a focus lens in the lens apparatus, second information relating to a focal distance of the lens apparatus, and third information relating to a tilt amount when a focal plane is tilted with respect to an imaging plane of an image sensor in the imaging apparatus; and generate distance information using the optical information, wherein the distance information relates to a distance to the focal plane that is tilted depending on the tilt amount.

### BACKGROUND

### Field of the Technology

The present disclosure relates to a controlling apparatus, a lens apparatus, an imaging apparatus, a control method of imaging system, and a non-transitory computer-readable storage medium.

### Description of the Related Art

There is known an imaging optical system having a tilt mechanism that drives a lens group of the imaging optical system to tilt a focal plane such that the entire plane of a tilted object plane can be focused on. Japanese Patent Laid-Open No. 2011-41092 discloses a configuration in which tilt information of a focal plane is displayed as an image on an imaging apparatus depending on a tilt amount of an imaging lens.

### SUMMARY

An embodiment of the present disclosure provides a controlling apparatus that can appropriately calculate a change in distance information depending on a tilt of a focal plane in a case where an imaging optical system has a tilt mechanism.

According to an embodiment of the present disclosure, there is provided a controlling apparatus used for an imaging system including a lens apparatus and an imaging apparatus, in which the controlling apparatus is configured to: acquire optical information that includes first information relating to a position of a focus lens in the lens apparatus, second information relating to a focal distance of the lens apparatus, and third information relating to a tilt amount when a focal plane is tilted with respect to an imaging plane of an image sensor in the imaging apparatus; and generate distance information using the optical information, wherein the distance information relates to a distance to the focal plane that is tilted depending on the tilt amount.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of a camera system according to an embodiment of the present disclosure.

FIG. 2 is a diagram for illustrating the Scheimpflug principle.

FIG. 3 is a diagram for illustrating an imaging distance that changes when a focal plane is tilted.

FIG. 4A is a diagram for illustrating a setting example of imaging distance display associated with a tilt of a focal plane according to Example 1.

FIG. 4B is a diagram for illustrating a setting example of the imaging distance display associated with a tilt of the focal plane according to Example 1.

FIG. 4C is a diagram for illustrating a setting example of the imaging distance display associated with a tilt of the focal plane according to Example 1.

FIG. 5 is a flowchart for illustrating processing when an imaging distance is calculated by a lens calculating unit according to Example 1.

FIG. 6 is a flowchart for illustrating processing when an imaging distance is calculated by a camera calculating unit according to Example 1.

FIG. 7A is a diagram for illustrating a setting example of imaging distance display associated with a tilt of a focal plane and a focus frame change according to Example 2.

FIG. 7B is a diagram for illustrating a setting example of the imaging distance display associated with the tilt of the focal plane and the focus frame change according to Example 2.

FIG. 7C is a diagram for illustrating a setting example of the imaging distance display associated with the tilt of the focal plane and the focus frame change according to Example 2.

### DESCRIPTION OF THE EMBODIMENTS

Hereinafter, embodiments and examples for implementing the present disclosure will be described in detail with reference to the drawings. Note that dimensions, materials, shapes, relative positions between components, and the like described in the following embodiments and the examples can be freely determined, and can be changed depending on a configuration of an apparatus to which the present disclosure is applied and various conditions. In addition, in the drawings, the same reference numerals between the drawings are used to represent identical or functionally similar elements.

As described above, Japanese Patent Laid-Open No. 2011-41092 discloses a configuration in which tilt information of a focal plane is displayed as an image on an imaging apparatus depending on a tilt amount of an imaging lens. However, Japanese Patent Laid-Open No. 2011-41092 does not describe specific numerical values regarding an imaging distance that changes when a focal plane is tilted depending on a tilt of the imaging lens. On the other hand, in an embodiment of the present disclosure, a camera system that can appropriately calculate a change in imaging distance information depending on a tilt of a focal plane in a case where an imaging optical system has a tilt mechanism will be described.

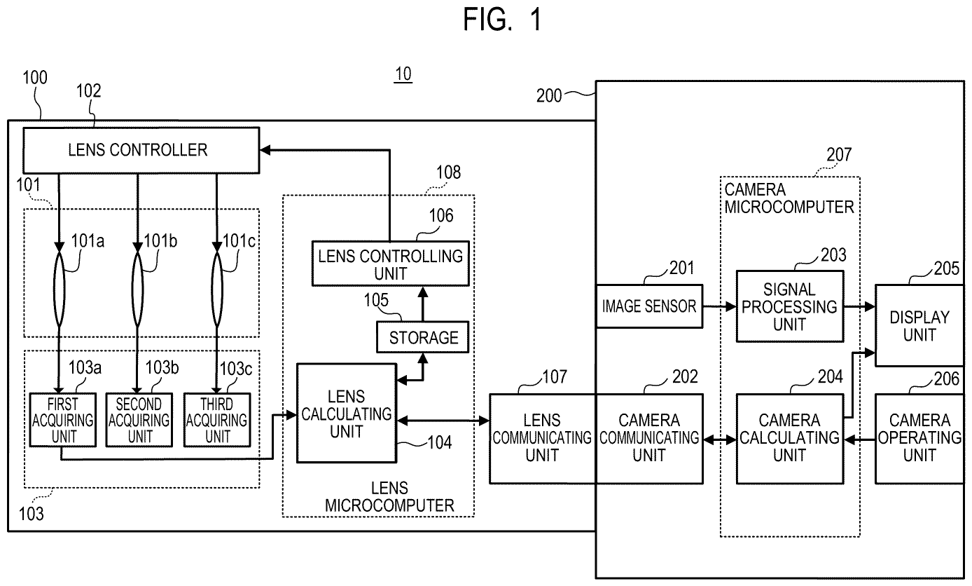

First, a camera system according to an embodiment of the present disclosure will be described with reference to FIG. 1 to FIG. 3. FIG. 1 is a block diagram of a camera system 10 according to an embodiment of the present disclosure. The camera system 10 includes a camera body (imaging apparatus) 200 and a lens apparatus 100 that is attachable to and detachable from the camera body 200. Note that the configuration of the camera system 10 is not limited to this example. For example, the camera body 200 and the lens apparatus 100 may be integrated.

The lens apparatus 100 is mechanically and electrically connected to the camera body 200 through a mount (not illustrated). The lens apparatus 100 receives supply of electrical power from the camera body 200 through an electrical terminal (not illustrated) provided in the mount. The lens apparatus 100 controls various actuators and a lens microcomputer 108 described below using the electrical power received from the camera body 200. The camera body 200 communicates with the lens apparatus 100 through a camera communicating unit 202 provided in the mount, and transmits a control command to the lens apparatus 100 to control the lens apparatus 100.

In the camera body 200, an image sensor 201, the camera communicating unit 202, a display unit 205, a camera operating unit 206, and a camera microcomputer 207 are provided. In the camera microcomputer 207, a signal processing unit 203 and a camera calculating unit 204 are provided.

The image sensor 201 includes a photoelectric conversion element such as a CMOS sensor or a CCD sensor, and outputs an electrical signal (analog signal) by photoelectrically converting a subject image (optical image) that is formed by the imaging optical system in the lens apparatus 100. The analog signal output from the image sensor 201 is converted into a digital signal by an A/D conversion circuit (not illustrated).

The signal processing unit 203 generates an image signal by executing various image processing on the digital signal output from the A/D conversion circuit. In addition, the signal processing unit 203 generates information representing a contrast state of the subject image, that is, focus information representing a focus state of the imaging optical system, luminance information representing an exposure state, and the like from the image signal. As a method of generating the information from the image signal, any known method may be used. In addition, the signal processing unit 203 outputs the image signal to the display unit 205. The display unit 205 is configured using any display, and displays the image signal as a live view image used for verifying a composition, a focus state, or the like. Further, the signal processing unit 203 outputs the image signal to a recording processing unit (not illustrated). The recording processing unit stores the image signal in an external memory or the like as still image or moving image data.

The camera microcomputer 207 controls the camera body 200 in response to an input of the imaging instruction switch and various setting switches, and the like in the camera operating unit 206. The camera communicating unit 202 transmits a control command corresponding to the input of the camera operating unit 206 to the lens microcomputer 108 through a communication terminal portion.

In the lens apparatus 100, an optical system (imaging optical system) 101, a lens controller 102, an acquisition unit 103, and the lens microcomputer 108 are provided. In the optical system 101, a focus lens group 101a, a zoom lens group 101b, and a tilt lens group 101c are provided. In the acquisition unit 103, a first acquisition unit 103a that acquires information of the focus lens group 101a, a second acquisition unit 103b that acquires information of the zoom lens group 101b, and a third acquisition unit 103c that acquires information of the tilt lens group 101c are provided. In the lens microcomputer 108, a lens calculating unit 104, a storage 105, and a lens controlling unit 106 are provided. In addition, although not illustrated in FIG. 1, in the lens apparatus 100, a shift lens group for the shift effect, an aperture stop unit for light amount adjustment, an image blur correction lens for image blur correction, a gyro sensor for posture detection, and the like are provided.

The lens controller 102 controls an actuator that drives each of the lens groups of the optical system 101 to control a position of each of the lens groups. The acquisition unit 103 acquires lens information (optical information) of each of the lens groups controlled by the lens controlling unit 106 from the first to third acquisition units 103a, 103b, and 103c and the like. Here, the lens information may include, for example, a position of the zoom lens (focal distance), a position of the focus lens (subject distance), an aperture position (F-value), a tilt/shift amount (a tilt amount and a shift amount), and a position of a rotation axis of the optical system 101.

The storage 105 stores optical information of the lens apparatus 100 and data (a function or a coefficient) representing a relationship between the tilt amount and a distance to a focal plane (imaging distance). The imaging distance depends on the tilt amount, a focal distance, a focus position, an angle of view, and the like. A storage (not illustrated) of the camera body 200 may store the data. The lens calculating unit 104 or the camera calculating unit 204 calculates the imaging distance using the data stored in the storage 105 or the storage of the camera body 200.

The lens apparatus 100 applies a desired tilt/shift amount to the lens controlling unit 106 depending on an operation amount of a lens operating unit (not illustrated). In the following description, the tilt/shift amount will be abbreviated as the TS amount. The lens operating unit is, for example, an electronic monitor, a rotary dial, or an ON/OFF switch, and may include an operation member where a user can input the TS amount or the degree of the TS amount can be selected from multiple stages (large, middle, small, and the like). The TS amount may be determined by the user operating the camera operating unit 206.

The lens controlling unit 106 calculates a control amount for realizing the desired TS amount. Based on the calculated control amount, the lens controlling unit 106 independently shifts a plurality of shift lens units in the tilt lens group 101c through the lens controller 102 in directions including a component of a direction perpendicular to an optical axis direction. By shifting the plurality of shift lens units, image plane tilt occurs due to lens decentration, and tilt driving and shift driving (TS driving) can be implemented. As a method of calculating the control amount for realizing the desired TS amount, any known method may be used.

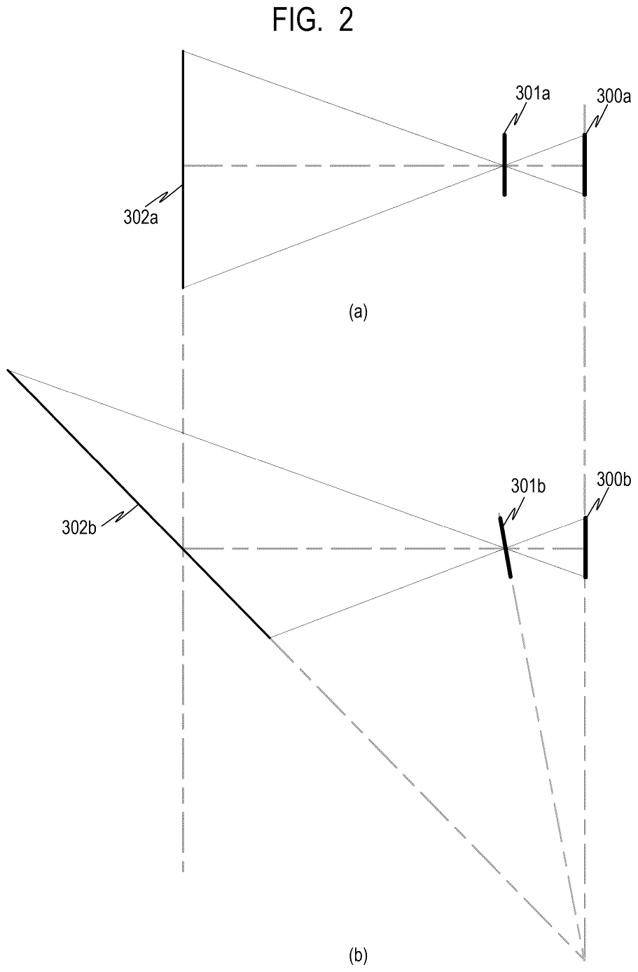

Here, the Scheimpflug principle will be described with reference to (a) and (b) of FIG. 2. (a) and (b) of FIG. 2 are diagrams for illustrating the Scheimpflug principle. When a principal plane of the optical system 101 in the lens apparatus 100 or the image sensor 201 is tilted, an in-focus range of the subject side is determined according to the Scheimpflug principle.

(a) of FIG. 2 shows an in-focus range when the principal plane of the optical system 101 is not tilted with respect to an imaging plane. (b) of FIG. 2 shows an in-focus range when the principal plane of the optical system 101 is tilted with respect to the imaging plane by using a principal point of the optical system 101 as the rotation center (rotation axis). In (a) and (b) of FIG. 2, imaging planes 300a and 300b, principal planes 301a and 301b of the optical system 101, and in-focus subject planes 302a and 302b are shown.

The Scheimpflug principle refers to a principle in which, when the imaging plane 300b and the principal plane 301b of the optical system 101 intersect each other on one straight line, the subject plane 302b also passes through the same straight line. In addition, when the rotation center of the principal plane 301b of the optical system 101 is positioned in front or rear of the principal point of the optical system 101, composition shift occurs due to a change in the optical axis. Even in this case, the Scheimpflug principle is also satisfied.

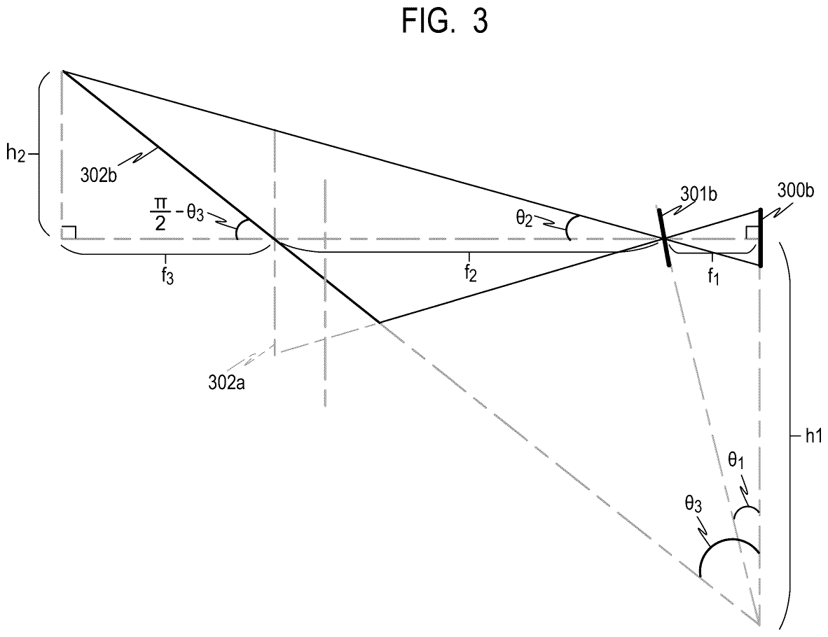

Further, a method of calculating the distance to the focal plane tilted by tilting will be described with reference to FIG. 3. FIG. 3 is a diagram for illustrating the calculation of the distance to the tilted focal plane.

In FIG. 3, it is assumed that a tilt amount θ₁, an angle of view θ₂, a focal distance f₁, and a subject distance f₂ are known. Here, Expressions (1) and (2) below are satisfied.

$${f}_{1} = {h}_{1} * tan {θ}_{1} \qquad ( 1 )$$

$${f}_{1} + {f}_{2} = {h}_{1} * t a n {θ}_{3} \qquad ( 2 )$$

When simultaneous equations of Expressions (1) and (2) are solved, Expression (3) below is obtained, and an angle θ₃ can be derived.

$${θ}_{3} = arctan ( \frac{{f}_{1} + {f}_{2}}{{f}_{1}} * tan {θ}_{1} ) \qquad ( 3 )$$

Next, similarly, Expressions (4) and (5) below are satisfied in FIG. 3.

$${h}_{2} = ( {f}_{2} + {f}_{3} ) * tan {θ}_{2} \qquad ( 4 )$$

$${h}_{2} = {f}_{3} * t a n ( \frac{π}{2} - {θ}_{3} ) \qquad ( 5 )$$

When simultaneous equations of Expressions (4) and (5) are solved, Expression (6) below is obtained, and a distance f₃ can be derived.

$${f}_{3} = {f}_{2} * \frac{tan {θ}_{2} * tan {θ}_{3}}{1 - tan {θ}_{2} * tan {θ}_{3}} \qquad ( 6 )$$

Here, the subject distance f₂, the angle of view θ₂, and the angle θ₃ in Expression (6) are known. By executing the calculation as described above, the distance information to the tilted focal plane can be calculated. Therefore, by adding the focal distance f₁, the subject distance f₂, and the distance f₃, the imaging distance to the focal plane can be calculated. In addition, by changing the value of the angle of view θ₂, distance information corresponding to all the regions of the tilted focal plane can be obtained.

When a subject to be imaged has a depth, by tilting a subject plane along the depth of the subject, the front to the depth of the subject can be focused on. In a lens apparatus not including a tilt-shift mechanism, when it is desired to focus on a depth portion, a method of stopping down an aperture to increase the depth of field is generally used. On the other hand, in a lens apparatus (tilt-shift lens) including a tilt-shift mechanism, even when an aperture is opened, by tilting the principal plane of the optical system 101, the depth of the subject can be focused on. On the contrary, in the tilt-shift lens, by tilting the principal plane of the optical system 101 in a direction opposite to the tilt of the subject present at the depth, the subject plane can also be caused to intersect a depth direction of the subject at an angle close to the right angle. In this case, by extremely narrowing the in-focus range, a diorama-like image can be acquired.

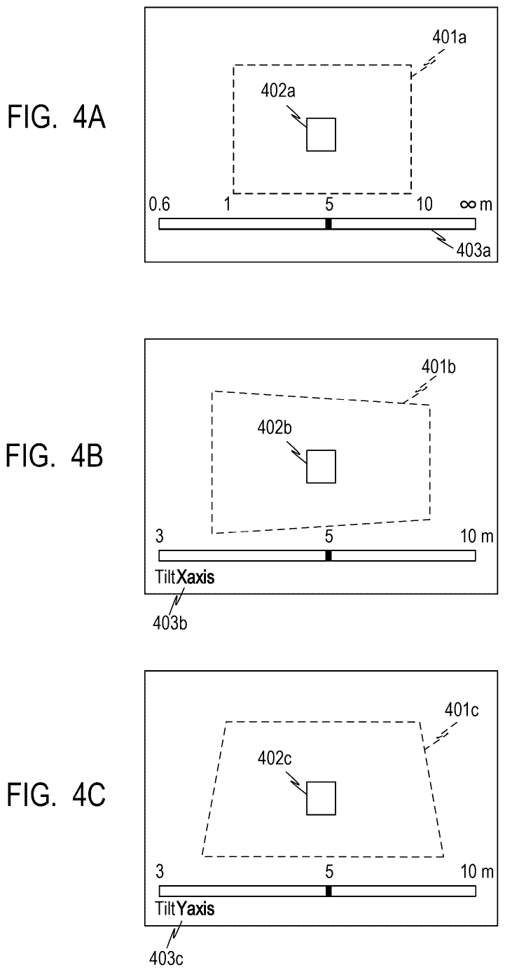

Hereinafter, a camera system, a lens apparatus, a camera body, and control methods thereof according to each example of the present disclosure will be described in detail with reference to FIG. 4A to FIG. 7C. It is assumed that the camera system according to each example described below has the same configuration as the camera system 10 described in the above-described embodiment. Note that the configuration of the camera system according to each example is not limited to the configuration described above. The camera system according to each example implements the TS driving using lens decentration, but may be configured to include the tilt-shift mechanism of shifting a lens barrel of the lens apparatus 100 for TS driving. In addition, likewise, the camera system according to each example may be configured to include the zoom lens group 101b, but may have a monofocal configuration not including the zoom lens group 101b.

### Example 1

In Example 1 of the present disclosure, when a focal plane is tilted by the TS driving, information of imaging distance display displayed by the display unit 205 is set (changed). The Example 1 describes a case where the rotation center is the principal point of the optical system 101.

FIG. 4A to FIG. 4C are diagrams for illustrating settings of imaging distance display associated with tilts of focal planes that are displayed on the display unit 205. In FIG. 4A to FIG. 4C, changes of focal planes 401a, 401b, and 401c are illustrated, respectively. In addition, in FIG. 4A to FIG. 4C, focus frames 402a, 402b, and 402c representing positions to be focused on and imaging distance displays 403a, 403b, and 403c representing imaging distance information are illustrated, respectively. In the examples illustrated in FIG. 4A to FIG. 4C, it is assumed that the focus frames 402a, 402b, and 402c are positioned at the center of the display unit 205.

FIG. 4A illustrates information that is displayed on the display unit 205 when the principal plane of the optical system 101 is not tilted with respect to the imaging plane. In the imaging distance display 403a, the focal plane 401a and the imaging plane are parallel to each other. Therefore, 0.6 that is the closest imaging distance is displayed at a left end, ∞ that is the infinite distance is displayed at a right end, and the current imaging distance of 5 m is indicated at a position of a black bar. In this case, the imaging distance changes depending on the focus position such that the position of the black bar also changes correspondingly. In addition, the focal plane is not tilted, and thus the end distance display is invariable.

FIG. 4B illustrates information that is displayed on the display unit 205, as illustrated in the focal plane 401b, when the right side of the optical system 101 is tilted with respect to the imaging plane to be positioned in the deep side and the focal plane is tilted in the lateral direction. In the imaging distance display 403b, the focal plane is tilted in the lateral direction. Therefore, the imaging distance corresponding to the lateral direction of the display unit 205 is displayed. In the example illustrated in FIG. 4B, in the imaging distance display 403b, the left end side of the display unit 205 is displayed as 3 m, the right end side thereof is displayed as 10 m, and an imaging distance of 5 m for the focus frame 402b is indicated at a position of a black bar. Here, the numerical values displayed on the left end side and the right end side of the display unit 205 indicate a minimum value and a maximum value in the imaging distance range (a minimum value and a maximum value of the imaging distance display) regarding the tilted focal plane. In addition, in the imaging distance display 403b, information representing that the tilt of the focal plane is in the lateral direction (for example, the focal plane is tilted in an X-axis direction) can be displayed.

Here, in FIG. 4B, the focus frame 402b is positioned at the center of the display unit 205 corresponding to the center of the imaging plane. However, the focus frame 402b may be freely shifted. For example, the focus frame 402b can be determined based on an instruction of a user, an automatic recognition function of a subject, or the like. In this case, the position of the black bar representing the imaging distance corresponding to the focus frame changes depending on the position of the focus frame 402b and the focus position. In the example illustrated in FIG. 4B, the focal plane is not tilted in the longitudinal direction. Therefore, the imaging distance in the longitudinal direction does not change.

FIG. 4C illustrates information that is displayed on the display unit 205, as illustrated in the focal plane 401c, when the upper side of the optical system 101 is tilted with respect to the imaging plane to be positioned in the deep side and the focal plane is tilted in the longitudinal direction. Here, the other configurations are the same as those of the example illustrated in FIG. 4B, except that the tilt is changed between the lateral direction and the longitudinal direction. Therefore, duplicate description will be omitted. In the example illustrated in FIG. 4C, in the imaging distance display 403c, the lower end side of the display unit 205 is displayed as 3 m, and the upper end side thereof is displayed as 10 m. In addition, in the imaging distance display 403c, information representing that the tilt of the focal plane is in the longitudinal direction (for example, the focal plane is tilted in a Y-axis direction) can be displayed. Here, the focal plane is not tilted in the lateral direction. Therefore, the imaging distance in the lateral direction does not change.

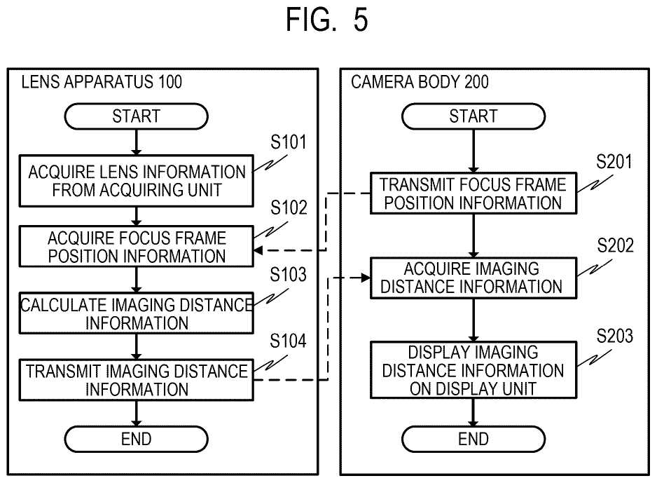

Hereinafter, processing of setting the imaging distance display according to the Example 1 will be described. First, processing of a case where the imaging distance information is calculated by the lens apparatus 100 will be described with reference to FIG. 5. FIG. 5 is a flowchart illustrating processing where the imaging distance information is calculated by the lens calculating unit 104 and the calculated imaging distance information is displayed on the display unit 205. In the following flow, Step S101 to Step S104 are processing that is executed by the lens apparatus 100, and Step S201 to Step S203 are processing that is executed by the camera body 200.

First, the processing that is executed by the lens apparatus 100 will be described. In Step S101, the acquisition unit 103 acquires each lens information of the optical system 101 from the first to third acquisition units 103a, 103b, 103c and the like. Here, the lens information includes, for example, the position of the zoom lens (focal distance), the position of the focus lens (subject distance), the aperture position (F-value), the TS amount, and the position of the rotation axis of the optical system 101, but is not limited thereto. The focal distance and the subject distance may be obtained with any known method using, for example, the position of the zoom lens and the position of the focus lens in the lens information.

In Step S102, the lens microcomputer 108 communicates with the camera microcomputer 207 through a lens communicating unit 107, and acquires focus frame position information from the camera microcomputer 207. Here, the focus frame position information includes, for example, the size of the image sensor 201 (angle of view) in addition to the information representing the position of the focus frame, but is not limited thereto. The focus frame position information may include, for example, the range of the focus frame.

In Step S103, the lens calculating unit 104 calculates the imaging distance information from the lens information and the focus frame position information. Here, the imaging distance information can include, for example, an imaging distance to a position to be focused on the focal plane. As a method of calculating the imaging distance, the method described with reference to FIG. 3 may be used, and the imaging distance may be obtained by adding the focal distance f₁, the subject distance f₂, and the distance f₃. Regarding the imaging distance from the center of the imaging plane 300b that is not affected by tilting, the distance f₃ is 0.

Further, the imaging distance information can include a minimum value and a maximum value of the imaging distance display. The minimum value and the maximum value of the imaging distance display can be determined with the method described with reference to FIG. 3 using the tilt amount θ₁, the angle of view θ₂, the focal distance f₁, and the subject distance f₂.

In Step S104, the lens microcomputer 108 transmits the imaging distance information calculated in Step S103 to the camera microcomputer 207. When the transmission of the imaging distance information is completed, the processing of setting the imaging distance display that is executed by the lens apparatus 100 ends.

Next, the processing that is executed by the camera body 200 will be described. In Step S201, the camera microcomputer 207 transmits the focus frame position information to the lens microcomputer 108. The information representing the position of the focus frame can be determined, for example, based on an instruction of a user, or an automatic recognition function of a subject.

In Step S202, the camera microcomputer 207 communicates with the lens microcomputer 108 through the camera communicating unit 202, and acquires the imaging distance information calculated in Step S103 from the lens microcomputer 108.

In Step S203, the camera microcomputer 207 causes the display unit 205 to display the imaging distance information acquired in Step S202. When the imaging distance information is displayed, the processing of setting the imaging distance display that is executed by the camera body 200 ends.

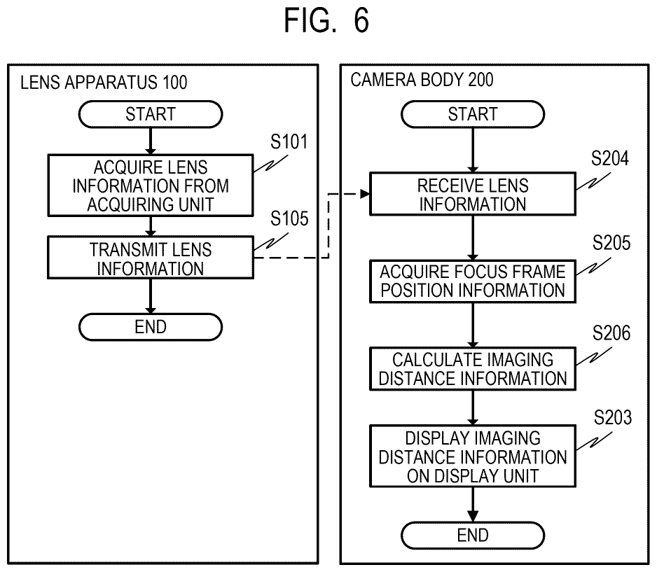

Next, the processing of the case where the imaging distance information is calculated by the camera body 200 will be described with reference to FIG. 6. FIG. 6 is a flowchart illustrating processing where the imaging distance information is calculated by the camera calculating unit 204 using the acquired lens information and is displayed on the display unit 205. In the following flow, Step S101 and Step S105 are processing that is executed by the lens apparatus 100, and Step S204, Step S205, Step S206, and Step S203 are processing that is executed by the camera body 200.

First, the processing that is executed by the lens apparatus 100 will be described. Since Step S101 is the same as the processing in the flow described using FIG. 5, the description thereof will be omitted. When the lens information is acquired in Step S101, the processing transitions to Step S105.

In Step S105, the lens microcomputer 108 communicates with the camera microcomputer 207 through the lens communicating unit 107, and transmits the lens information acquired in Step S101 to the camera microcomputer 207. When the transmission of the lens information is completed, the processing of setting the imaging distance display that is executed by the lens apparatus 100 ends.

Next, the processing that is executed by the camera body 200 will be described. In Step S204, the camera microcomputer 207 communicates with the lens microcomputer 108 through the camera communicating unit 202, and acquires the lens information from the lens microcomputer 108.

In Step S205, the camera microcomputer 207 acquires the focus frame position information in the display unit 205. Here, as described above, the focus frame position information can include, for example, the size of the image sensor 201 (angle of view) or the range of the focus frame in addition to the information representing the position of the focus frame, but is not limited thereto. In addition, the information representing the position of the focus frame can be determined, for example, based on an instruction of a user, or an automatic recognition function of a subject.

In Step S206, the camera calculating unit 204 calculates the imaging distance information using the same method as that of Step S103.

Since Step S203 is the same as the processing in the flow described using FIG. 5, the description thereof will be omitted. When the imaging distance information is displayed, the processing of setting the imaging distance display that is executed by the camera body 200 ends.

As described above, the camera system 10 that functions as an example of the imaging system according to the Example 1 includes the lens apparatus 100 and the camera body 200. The lens apparatus 100 functions as an example of a lens apparatus that can be mounted on the imaging apparatus. The camera body 200 on which the lens apparatus is mounted functions as an example of an imaging apparatus that communicates with the lens apparatus.

The lens apparatus 100 includes the acquisition unit 103 and the lens calculating unit 104. The acquisition unit 103 functions as an example of an acquisition unit that acquires optical information including the position of the focus lens for executing focus adjustment, the focal distance, and the tilt amount for tilting the principal plane of the optical system. Here, the lens information is an example of the optical information. The lens calculating unit 104 functions as an example of a calculating unit that calculates, using the optical information, the imaging distance information including the imaging distance relating to the focal plane tilted depending on the tilt amount.

With the above-described configuration, in a case where the imaging optical system has the tilt mechanism, the lens apparatus 100 according to the Example 1 can appropriately calculate a change in imaging distance information depending on the tilt of the focal plane. As a result, the operability for the user can be improved.

The optical information may include a shift amount for shifting the principal plane of the optical system in a direction perpendicular to the optical axis. With the above-described configuration, a change in imaging distance information can be appropriately calculated depending on a change of the focal plane by TS driving.

In addition, the imaging distance information may include a minimum value and a maximum value of the imaging distance relating to the focal plane tilted depending on the tilt amount. With the above-described configuration, as imaging information, the range of the imaging distance relating to the tilted focal plane can be appropriately calculated, and the operability for the user can be improved.

The lens apparatus 100 may further include the lens communicating unit 107 functioning as an example of a communicating unit that acquires the focus position information representing the position to be focused on from the camera body 200. Here, the focus frame position information is an example of the focus position information. In addition, using the focus position information and the optical information, the lens calculating unit 104 may calculate the imaging distance information including the imaging distance relating to the position to be focused on the focal plane. With the above-described configuration, the imaging distance regarding a desired position on the focal plane can be appropriately calculated, and the operability for the user can be improved.

In addition, the camera body 200 may include the camera microcomputer 207 functioning as an example of a display controlling unit that causes a display unit to display the imaging distance information transmitted from the lens apparatus 100. In addition, the display unit 205 may function as an example of a display unit. With the above-described configuration, by using the display unit 205 provided in the camera body 200, the imaging distance information relating to the focal plane tilted depending on the tilt amount can be appropriately calculated, the calculated imaging distance information can be displayed, and the operability for the user can be improved.

Here, as the imaging distance information, the camera microcomputer 207 may cause the display unit to display the range of the imaging distance corresponding to the tilt of the focal plane in the longitudinal axis direction or the range of the imaging distance corresponding to the tilt of the focal plane in the lateral axis direction. Here, the imaging distance display 403c includes an example of the range of the imaging distance corresponding to the tilt of the focal plane in the longitudinal axis direction. In addition, the imaging distance display 403b includes an example of the range of the imaging distance corresponding to the tilt of the focal plane in the lateral axis direction. With the above-described configuration, the user can easily grasp the range of the imaging distance corresponding to the tilt of the focal plane in the longitudinal axis direction or the lateral axis direction, and the operability for the user can be improved. In addition, when the imaging distance information corresponding to the focus frame position information is displayed, the user can easily grasp the imaging distance at the desired position in the range of the imaging distance corresponding to the tilt of the focal plane in the longitudinal axis direction or the lateral axis direction, and the operability for the user can be further improved.

As described above with reference to FIG. 6, the imaging distance information may be calculated by the camera body 200. The camera body 200 includes the camera communicating unit 202 and the camera calculating unit 204. The camera communicating unit 202 may function as an example of a communicating unit that acquires, from the lens apparatus 100, optical information including the position of the focus lens for executing focus adjustment, the focal distance, and the tilt amount for tilting the principal plane of the optical system. The camera calculating unit 204 may function as an example of a calculating unit that calculates, using the optical information, the imaging distance information including the imaging distance regarding the focal plane tilted depending on the tilt amount. Even with the camera body 200 having the above-described configuration, the same effect as that of the case where the imaging distance information is calculated by the lens apparatus 100 can be exhibited.

In the Example 1, the display unit 205 is provided in the camera body 200, but may be provided in the lens apparatus 100. In this case, the lens microcomputer 108 may function as an example of a display controlling unit that causes the display unit 205 to display the imaging distance information. With the above-described configuration, instead of the processing of Step S203, the lens microcomputer 108 can cause the display unit 205 provided in the lens apparatus 100 to display the imaging distance information. In the flow illustrated in FIG. 6, after calculating the imaging distance information in Step S206, the imaging distance information calculated by the camera microcomputer 207 may be transmitted to the lens apparatus 100.

In addition, the lens microcomputer 108 or the camera microcomputer 207 may function as an example of a controlling apparatus used for an imaging system 10 including the lens apparatus 100 and an imaging apparatus 200. The controlling apparatus may include: a memory storing instructions; and at least one processor configured to execute the instructions. The processor may execute the instructions to acquire optical information that includes first information relating to a position of a focus lens in the lens apparatus 100, second information relating to a focal distance of the lens apparatus 100, and third information relating to a tilt amount when a focal plane is tilted with respect to an imaging plane of an image sensor in the imaging apparatus 200. In addition, the processor may execute the instructions to generate distance information relating to a distance to the focal plane that is tilted depending on the tilt amount using the optical information. Even with the above-described configuration, in a case where the imaging optical system has the tilt mechanism, a change in imaging distance information depending on the tilt of the focal plane can be appropriately calculated. As a result, the operability for the user can be improved.

In this case, the optical information may include fourth information relating to a shift amount when the focal plane is shifted in a direction perpendicular to an optical axis. With the above-described configuration, a change in imaging distance information can be appropriately calculated depending on a change of the focal plane by the TS driving. In addition, the distance information may include information relating to at least one of a minimum value and a maximum value of the distance to the focal plane that is tilted depending on the tilt amount. With the above-described configuration, as imaging information, the range of the imaging distance regarding the tilted focal plane can be appropriately calculated, and the operability for the user can be improved.

Further, the processor may be further configured to execute the instruction to acquire instruction information relating to a focus position from the imaging apparatus 200, and to generate the distance information using the optical information and the instruction information. With the above-described configuration, the imaging distance regarding a desired position on the focal plane can be appropriately calculated, and the operability for the user can be improved. The distance information may be used for display on a display unit of the imaging system 10. With the above-described configuration, the operability for the user can be improved.

The lens apparatus 100 can function as an example of a lens apparatus including the controlling apparatus and the focus lens.

In addition, an imaging apparatus 300 may also function as an example of an imaging apparatus including the controlling apparatus and the image sensor. The imaging apparatus 300 may further include a display unit configured to execute display using the distance information. In addition, the display unit 205 can function as an example of the display unit.

Here, the display unit may display at least one of a range of the distance corresponding to the tilt of the focal plane with respect to a first axis perpendicular to an optical axis and a range of the distance corresponding to the tilt of the focal plane with respect to a second axis perpendicular to the optical axis and the first axis. In addition, the display unit may display a range of the distance corresponding to a range of a focus position instructed from the imaging apparatus 300. Further, the display unit may display a range of the distance corresponding to a depth of field of the lens apparatus 100. With the above-described configuration, the user can easily grasp the range of the distance corresponding to the tilt of the focal plane, and the operability for the user can be improved. In addition, in a case where the range of the distance corresponding to the range of the focus position is displayed, the user can easily grasp the distance information at the desired position in the range of the distance corresponding to the tilt of the focal plane, and the operability for the user can be further improved.

### Example 2

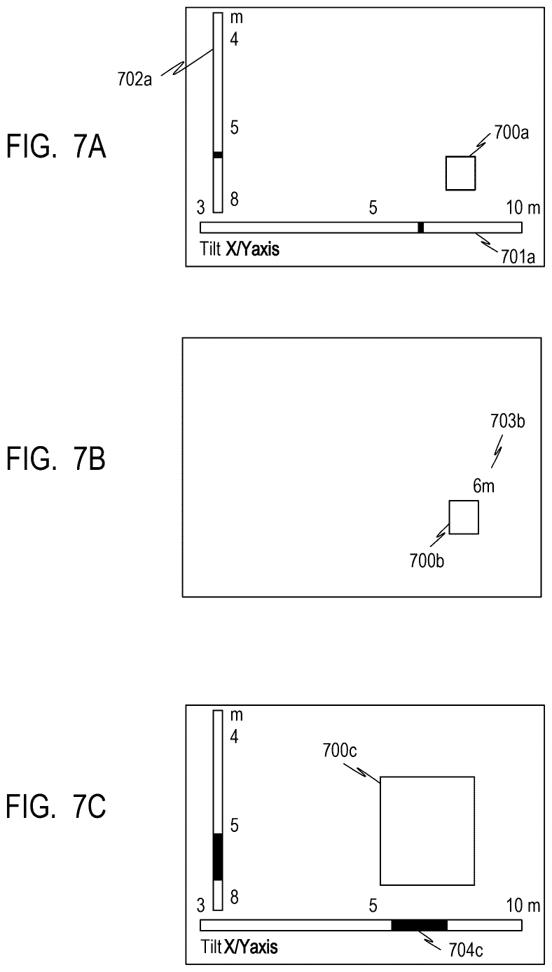

In the Example 1, the case where the optical system 101 is tilted in the lateral direction or the longitudinal direction with respect to the imaging plane has been described. In Example 2 of the present disclosure, a case where the optical system 101 is tilted in a direction oblique to an imaging plane will be described as an example. Hereinafter, the Example 2 will be described with reference to FIG. 7A to FIG. 7C. Since a method of setting the imaging distance information in the Example 2 is the same as that of the Example 1, the detailed description thereof will be omitted.

FIG. 7A to FIG. 7C are diagrams for illustrating various deformations of the imaging distance display in a case where the optical system 101 is tilted in the direction oblique to the imaging plane. In FIG. 7A to FIG. 7C, focus frames 700a, 700b, and 700c are illustrated, respectively.

FIG. 7A illustrates an example where the display unit 205 displays lateral-direction imaging distance display 701a and longitudinal-direction imaging distance display 702a. Here, the minimum values and the maximum values of the lateral-direction imaging distance display 701a and the longitudinal-direction imaging distance display 702a change depending on the TS amount as described above in the Example 1. In addition, positions of black bars representing the current imaging distance change depending on a position of the focus frame 700a. The black bars displayed in the imaging distance displays 701a and 702a indicate the imaging distance regarding the focus frame 700a. Since the black bars displayed by the imaging distance displays 701a and 702a indicate the same imaging distance, the positions of the black bars are at the equivalent positions in the imaging distance displays 701a and 702a, respectively.

Positions where the minimum value and the maximum value of the longitudinal-direction imaging distance display 702a are disposed may be set to positions corresponding to the tilt of the focal plane. For example, when the focal plane is tilted such that the lower side of the focal plane is positioned in the deep side, the minimum value of the longitudinal-direction imaging distance display 702a is displayed on the upper side of the screen, and the maximum value thereof may be displayed on the lower side of the screen. Conversely, when the focal plane is tilted such that the upper side of the focal plane is positioned in the deep side, the minimum value of the longitudinal-direction imaging distance display 702a may be displayed on the lower side of the screen, and the maximum value thereof may be displayed on the upper side of the screen. Regarding the lateral-direction imaging distance display 701a, likewise, positions where the minimum value and the maximum value are disposed may be set to positions corresponding to the tilt of the focal plane.

As in the Example 1, the minimum values and the maximum values of the lateral-direction imaging distance display 701a and the longitudinal-direction imaging distance display 702a of the case illustrated in FIG. 7A can be determined using the tilt amount θ₁, the angle of view θ₂, the focal distance f₁, and the subject distance f₂. Note that the maximum values and the minimum values of each of the lateral-direction imaging distance display 701a and the longitudinal-direction imaging distance display 702a can be determined using the tilt amount θ₁ and the angle of view θ₂ corresponding to the direction.

FIG. 7B illustrates an example where imaging distance information 703b representing a value of an imaging distance corresponding to the position of the focus frame 700b is displayed. In this case, the imaging distance for the position of the focus frame 700b can be uniquely calculated when the focus frame 700b is sufficiently small.

FIG. 7C illustrates an example where display (black bar) of an imaging distance display 704c is changed when the range of the focus frame 700c is wide or when the depth of field is changed. In this case, since the focus frame 700c is sufficiently large, the imaging distance changes depending on the position in the frame. In addition, the imaging distance also changes depending on the value of the depth of field. Therefore, in the example, the camera microcomputer 207 changes the width (range) of the display in the imaging distance display 704c depending on the width (range) of the imaging distance that changes depending on the position in the frame. As a result, the user can grasp the range of imaging distance corresponding to the range of the focus frame or the depth of field, and thus the operability of the user can be improved.

In the example illustrated in FIG. 7C, for example, the focus frame position information may include information on the range of the focus frame. In this case, the lens calculating unit 104 or the camera calculating unit 204 can calculate the imaging distance information including the range of the imaging distance corresponding to the focus frame using the information on the range of the focus frame in the focus frame position information.

As described above, even with the configuration according to the Example 2, the imaging distance display changes depending on a change of the focal plane by the TS driving. As a result, the operability for the user can be improved, and appropriate distance display can be executed.

For example, as the imaging distance information, the lens microcomputer 108 or the camera microcomputer 207 may display at least one of the range of the imaging distance corresponding to the tilt of the focal plane in the longitudinal axis direction and the range of the imaging distance corresponding to the tilt of the focal plane in the lateral axis direction. Here, the longitudinal-direction imaging distance display 702a includes an example of the range of the imaging distance corresponding to the tilt of the focal plane in the longitudinal axis direction. In addition, the lateral-direction imaging distance display 701a includes an example of the range of the imaging distance corresponding to the tilt of the focal plane in the lateral axis direction. With the above-described configuration, the user can easily grasp the range of the imaging distance corresponding to the tilt of the focal plane in the longitudinal axis direction and the lateral axis direction, and the operability for the user can be improved.

In addition, the focus position information may include the range of the position to be focused on. Here, the information of the range of the focus frame is an example of the range of the position to be focused on. In this case, as the imaging distance information, the lens microcomputer 108 or the camera microcomputer 207 may cause the display unit 205 to display the range of the imaging distance corresponding to the range of the position to be focused on. With the above-described configuration, the imaging distance regarding a desired range on the focal plane can be appropriately calculated, and the operability for the user can be improved.

In addition, the optical information may include the depth of field. In this case, as the imaging distance information, the lens microcomputer 108 or the camera microcomputer 207 may cause the display unit 205 to display the range of the imaging distance corresponding to the depth of field. With the above-described configuration, the imaging distance corresponding to the desired depth of field regarding the tilted focal plane can be appropriately calculated, and the operability for the user can be improved.

In the Example 1 and Example 2, the imaging distance information is calculated based on the focus frame position information. However, the calculated imaging distance information does not need to include the imaging distance corresponding to the focus frame. For example, the imaging distance information may include only the minimum value and the maximum value of the imaging distance information corresponding to the tilt of the focal plane, and the camera microcomputer 207 or the lens microcomputer 108 may cause the display unit 205 or the like to display only the minimum value and the maximum value of the calculated imaging distance information.

In addition, in the Example 1 and Example 2, various display examples are described. However, a configuration capable of switching between these displays may be adopted. In addition, the aspects of the imaging distance display described in the Examples 1 and 2 are exemplary, and other display aspects may be adopted. For example, instead of shifting the display (for example, the black bar) representing the imaging distance corresponding to the focus frame, a display aspect where the display is not shifted and a value of the imaging distance indicated by the display, a scale representing the imaging distance, or the like is changed based on the calculated imaging distance information may be adopted. Other Examples

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Here, the processor or circuit may include a central processing unit (CPU), a micro processing unit (MPU), a graphics processing unit (GPU), an application specific integrated circuit (ASIC), or a field-programmable gate array (FPGA). In addition, the processor or circuit may include a digital signal processor (DSP), a data flow processor (DFP), or a neural processing unit (NPU).

According to an aspect of the present disclosure, a change in imaging distance information depending on a tilt of a focal plane can be appropriately calculated in a case where an imaging optical system has a tilt mechanism. In addition, according to each of the examples, a change of a focal plane occurring during a tilt and shift driving can be reflected on the display unit 205. Therefore, a lens apparatus that can smoothly transition to a focusing operation can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023208, filed Feb. 17, 2025, which is hereby incorporated by reference herein in its entirety.

What is claimed is:

1. A controlling apparatus used for an imaging system including a lens apparatus and an imaging apparatus, the controlling apparatus comprising:
a memory storing instructions; and
at least one processor configured to execute the instructions to:
acquire optical information that includes first information relating to a position of a focus lens in the lens apparatus, second information relating to a focal distance of the lens apparatus, and third information relating to a tilt amount when a focal plane is tilted with respect to an imaging plane of an image sensor in the imaging apparatus; and
generate distance information using the optical information,
wherein the distance information relates to a distance to the focal plane that is tilted depending on the tilt amount.

2. The controlling apparatus according to claim 1, wherein the optical information includes fourth information relating to a shift amount when the focal plane is shifted in a direction perpendicular to an optical axis.

3. The controlling apparatus according to claim 1, wherein the distance information includes information relating to at least one of the minimum value and the maximum value of the distance to the focal plane that is tilted depending on the tilt amount.

4. The controlling apparatus according to claim 1, wherein the at least one processor is configured to execute the instructions to:
acquire instruction information relating to a focus position from the imaging apparatus; and
generate the distance information using the optical information and the instruction information.

5. The controlling apparatus according to claim 1, wherein the distance information is used for display on a display unit of the imaging system.

6. A lens apparatus comprising:
the controlling apparatus according to claim 1; and
the focus lens.

7. An imaging apparatus comprising:
the controlling apparatus according to claim 1; and
the image sensor.

8. The imaging apparatus according to claim 7, further comprising a display unit configured to execute display using the distance information.

9. The imaging apparatus according to claim 8, wherein the display unit displays at least one of a range of the distance corresponding to the tilt of the focal plane with respect to a first axis perpendicular to an optical axis and a range of the distance corresponding to the tilt of the focal plane with respect to a second axis perpendicular to the optical axis and the first axis.

10. The imaging apparatus according to claim 8, wherein the display unit displays a range of the distance corresponding to a range of a focus position instructed from the imaging apparatus.

11. The imaging apparatus according to claim 8, wherein the display unit displays a range of the distance corresponding to a depth of field of the lens apparatus.

12. A control method of an imaging system including a lens apparatus and an imaging apparatus, the method comprising:
acquiring optical information that includes first information relating to a position of a focus lens in the lens apparatus, second information relating to a focal distance of the lens apparatus, and third information relating to a tilt amount when a focal plane is tilted with respect to an imaging plane of an image sensor in the imaging apparatus; and
generating distance information using the optical information,
wherein the distance information relates to a distance to the focal plane that is tilted depending on the tilt amount.

13. A non-transitory computer-readable storage medium storing a program for causing a computer to execute the method according to claim 7.
